(19) United States
(12) Patent Application Publication
(10) Pub. No.: US 2024/0169783 A1
(43) Pub. Date: May 23, 2024

(54) CHECKOUT APPARATUS AND METHOD

(71) Applicant: TOSHIBA TEC KABUSHIKI KAISHA, Tokyo (JP)

(72) Inventor: Hideki Sano, Sunto Shizuoka (JP)

(21) Appl. No.: 18/329,603

(22) Filed: Jun. 6, 2023

(30) Foreign Application Priority Data
Nov. 18, 2022 (JP) 2022-185027

(51) Int. Cl. G07D 1/06; G06Q 20/18; G07G 1/00

(52) U.S. Cl. CPC G07D 1/06; G06Q 20/18; G07G 1/0036

(57) ABSTRACT

According to one embodiment, a checkout apparatus includes a coin change machine configured to dispense stored coins as change, a bill change machine configured to dispense stored bills as change, a change calculation unit configured to calculate a change amount, a first determination unit configured to determine whether the amount of coins is equal to or more than an amount of a minimum amount bill, a second determination unit configured to determine whether the calculated change amount is equal to or more than the amount of the minimum amount bill, and a change unit configured to output, to the coin change machine, a coin dispensing signal for dispensing, with coins, an amount not exceeding an amount of deposited coins and equal to or more than the amount of the minimum amount bill in the change amount.

### CROSS-REFERENCE TO RELATED APPLICATION

This application is based upon and claims the benefit of priority from Japanese Patent Application No. 2022-185027, filed on Nov. 18, 2022, the entire contents of which are incorporated herein by reference.

### FIELD

Embodiments described herein relate generally to a checkout apparatus and method.

### BACKGROUND

In stores such as a supermarket, a volume retailer, and a convenience store, a self-service type POS (Point of Sales) terminal (hereinafter referred to as “self-service POS”) is introduced in relation to sales of commodities and the like. In such a POS terminal, a customer performs registration operation and checkout operation for commodities by himself or herself. A semi-self-service type POS system (hereinafter referred to as “semi-self-service POS”) is also introduced in relation to sales of commodities and the like. The semi-self-service POS includes a commodity registration apparatus and a checkout apparatus. An operator such as a store clerk performs registration operation for commodities in the commodity registration apparatus. A customer himself or herself performs checkout operation in the checkout apparatus.

The self-service POS or the checkout apparatus in the semi-self-service POS explained above includes, on a housing inside, a change machine (a coin change machine and a bill change machine) in preparation for checkout by cash. If performing the checkout by cash, a customer deposits cash to the change machine for payment in the self-service POS or the checkout apparatus. If there is change, the change machine dispenses the change to the customer.

Incidentally, if a bill is exchanged for coins (for example, one 1000-yen bill is exchanged for ten 100-yen coins) or coins are exchanged for a bill (for example, ten 100-yen coins are exchanged for one 1000-yen bill; the exchange from coins to a bill is hereinafter referred to as “reverse exchange”) in a bank, a bank fee is sometimes collected recently. Therefore, if checking out in the self-service POS or the checkout apparatus in the semi-self-service POS, a person who desires to perform the reverse exchange sometimes deposits a large volume of coins far exceeding a total amount of a commodity and receives change with bills (for example, purchases a 100-yen commodity, deposits coins for 1100 yen, and receives 1000 yen in bills as change) in order to avoid payment of a bank fee. In the reverse exchange performed using the self-service POS or the checkout apparatus in the semi-self-service POS in this way, the self-service POS or the checkout apparatus in the semi-self-service POS is used differently from its proper use. This sometimes causes a problem for a store.

### BRIEF DESCRIPTION OF THE DRAWINGS

FIG. 1 is a perspective view illustrating an exterior of a self-service POS terminal according to an embodiment;

FIG. 2 is a block diagram illustrating a hardware configuration of the self-service POS terminal;

FIG. 3 is a block diagram illustrating a hardware configuration of a coin change machine;

FIG. 4 is a block diagram illustrating a hardware configuration of a bill change machine;

FIG. 5 is a functional block diagram illustrating a functional configuration of the self-service POS terminal;

FIG. 6 is a flowchart illustrating a flow of control processing of the self-service POS terminal;

FIG. 7 is a flowchart illustrating a flow of checkout processing by cash of the self-service POS terminal;

FIG. 8 is a diagram illustrating a display example of the self-service POS terminal;

FIG. 9 is a diagram illustrating another display example of the self-service POS terminal;

FIG. 10 is a diagram illustrating still another display example of the self-service POS terminal;

FIG. 11 is a diagram illustrating yet another display example of the self-service POS terminal;

FIG. 12 is a flowchart illustrating a flow of control processing of the coin change machine; and

FIG. 13 is a flowchart illustrating a flow of control processing of the bill change machine.

### DETAILED DESCRIPTION

An aspect of embodiments is to provide a checkout apparatus and method capable of preventing reverse exchange.

In general, according to one embodiment, a checkout apparatus is a checkout apparatus in which a customer himself or herself performs checkout operation relating to purchase of a commodity, the checkout apparatus including: a coin change machine capable of storing deposited coins and configured to dispense the stored coins as change and output coin amount information relating to an amount of coins deposited in one transaction; a bill change machine capable of storing deposited bills and configured to dispense the stored bills as change and output bill amount information relating to an amount of bills deposited in one transaction; a change calculation unit configured to calculate a change amount based on a purchase amount of the commodity and the output coin amount information and the output bill amount information; a first determination unit configured to determine whether the amount of coins included in the coin amount information input from the coin change machine is equal to or more than an amount of a minimum amount bill; a second determination unit configured to determine whether the calculated change amount is equal to or more than the amount of the minimum amount bill; and a change unit configured to, if the first determination unit determines that the amount of the coins is equal to or more than the amount of the minimum amount bill and the second determination unit determines that the change amount is equal to or more than the amount of the minimum amount bill, output, to the coin change machine, a coin dispensing signal for dispensing, with coins, an amount not exceeding the amount of the deposited coins and equal to or more than the amount of the minimum amount bill in the change amount.

A checkout apparatus and method according to an embodiment are explained below with reference to the accompanying drawings. In the embodiment, a self-service POS (Point of Sales) terminal in which a customer himself or herself executes commodity sales operation and settlement operation is explained as an example of the checkout apparatus. Embodiments are not limited by the embodiment explained below.

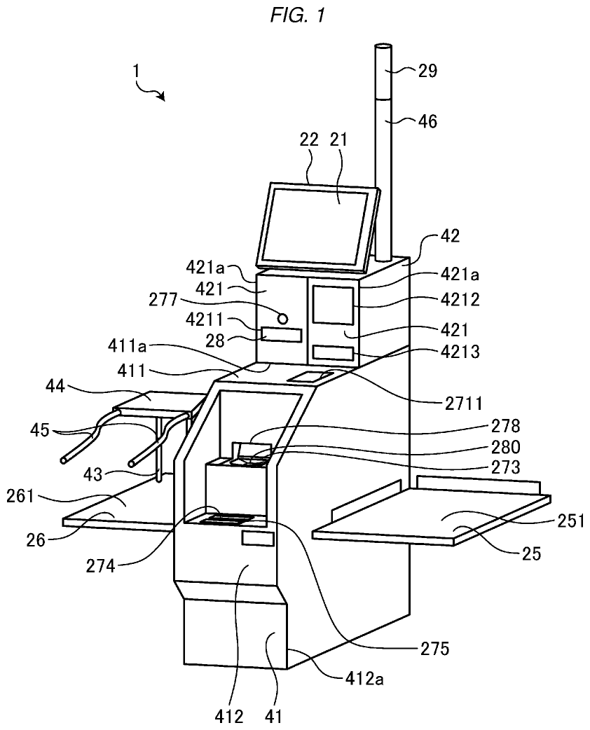

FIG. 1 is a perspective view illustrating an exterior of a self-service POS terminal 1 according to an embodiment. The self-service POS terminal 1 is a commodity sales data processing apparatus including a registration unit that reads a code symbol such as a barcode attached to a commodity to be purchased and a checkout unit that performs checkout processing based on commodity information specified by the read code symbol. A customer himself or herself performs both of commodity registration operation in the registration unit and checkout operation in the checkout unit. The commodity registration operation means operation for causing the registration unit to optically read the code symbol or operation for imaging the code symbol. The checkout operation means operation for the self-service POS terminal 1 to perform the checkout processing for a commodity for which the commodity registration operation was performed.

The self-service POS terminal 1 executes commodity registration processing based on the commodity registration operation performed by the customer. The self-service POS terminal 1 executes checkout processing based on the checkout operation performed by the customer.

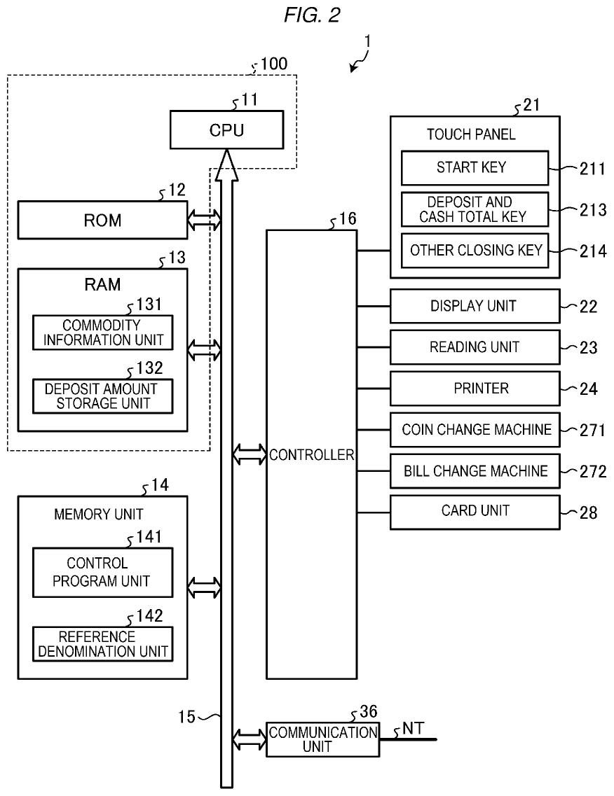

The commodity registration processing means processing for displaying commodity information such as a commodity name and a price of the commodity based on a commodity code acquired by the read code symbol and storing the commodity information in a commodity information unit 131 (see FIG. 2). The checkout processing means processing for displaying, based on the commodity information of the commodity subjected to the commodity registration processing, a total amount and a change amount relating to a transaction with the customer and performing settlement.

As illustrated in FIG. 1, the self-service POS terminal 1 includes a first housing 41 and a second housing 42. The first housing 41 houses a coin change machine 271 (see FIG. 2) and a bill change machine 272 (see FIG. 2) on the inside. The coin change machine 271 receives coins deposited by a customer and stores the coins for each of denominations. The coin change machine 271 dispenses coins serving as change to the customer using the stored coins. If the coins are deposited, the coin change machine 271 outputs information concerning a total amount and the numbers for each of the denominations of the deposited coins (collectively referred to as “coin amount information”). The bill change machine 272 receives bills deposited by the customer and stores the bills for each of denominations. The bill change machine 272 dispenses bills serving as change to the customer using the stored bills. If the bills are deposited, the bill change machine 272 outputs information concerning a total amount and the numbers for each of the denominations of the deposited bills (collectively referred to as “bill amount information”).

The first housing 41 includes a depositing section 2711 (a coin depositing port) for depositing coins to the coin change machine 271. The first housing 41 includes a coin dispensing port 273 for dispensing coin change and a coin receiving tray 280 for receiving the dispensed coins. The coin dispensing port 273 and the coin receiving tray 280 are components of the coin change machine 271 and are exposed to the outside of the first housing 41 from an opening section 278. The first housing 41 includes a bill depositing port 274 for receiving deposit of bills and a bill dispensing port 275 for dispensing bill change.

The first housing 41 includes a first door 411 and a second door 412 that can be opened and closed. The first door 411 turns in the up-down direction centering on a hinge section 411a. The second door 412 turns in the left-right direction centering on a hinge section 412a. The second door 412 is interfered by the first door 411. To open the second door 412, first, it is necessary to open the first door 411 in the upward direction. If both of the first door 411 and the second door 412 are in a closed state, only the second door 412 cannot be opened. The first door 411 turns upward, whereby the inner upper side of the first housing 41 is opened and the coin change machine 271 and the bill change machine 272 are exposed.

The first housing 41 includes a placing table 25 and a placing table 26 on the left and right sides. The placing table 25 includes a first measurement unit 251. The placing table 26 includes a second measurement unit 261.

The placing table 25 is a table on which a basket including commodities to be purchased are placed. The first measurement unit 251 measures a total weight of the basket placed on the placing table 25 and the commodities in the basket. The placing table 26 is a table on which a bag in which the commodities taken out from the placing table 25 is put is set. The second measurement unit 261 measures a total weight of the bag set on the placing table 26 and the commodities in the bag.

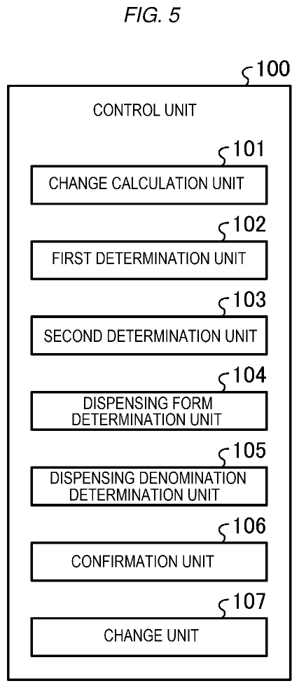

The placing table 26 includes two columns 43 extending upward from the upper surface of the placing table 26 and a temporary placing table 44 and two extension bars 45 formed above the columns 43. The extension bars 45 are bars for setting a bag (not illustrated) in which commodities, commodity codes of which are read by a reading unit 23 (see FIG. 2), are put. The bag is opened with a grip thereof hung on the extension bars 45 to make it easy to put the commodities. The temporary placing table 44 is a table for temporarily placing fragile commodities (for example, tofu and eggs) among the commodities, the commodity codes of which were read by the reading unit 23 (see FIG. 5). The commodities placed on the temporary placing table 44 are put in the bag last.

The second housing 42 is provided above the first housing 41. The second housing 42 houses the reading unit 23 and a card unit 28 (for both of which, see FIG. 2) on the right side in FIG. 1. The second housing 42 houses a printer 24 (see FIG. 2) on the left side in FIG. 1. For example, the reading unit 23 optically reads or images and reads a code symbol such as a barcode or a two-dimensional code attached to a commodity. The card unit 28 reads customer specifying information from, for example, a credit card inserted into the card unit 28. If credit card settlement is performed, the self-service POS terminal 1 executes settlement processing based on the customer specifying information read by the card unit 28. The printer 24 prints, on receipt paper, commodity information and checkout information of a commodity subjected to commodity registration processing by the self-service POS terminal 1 and dispenses a receipt.

The second housing 42 includes two third doors 421 that turn between an opened position and a closed position. The third doors 421 turn in a biparting manner centering on hinge sections 421a. In an opened state in which the third doors 421 are located in the opened position, the second housing 42 is opened and the reading unit 23, the printer 24, and the card unit 28 are exposed. In a closed state in which the third doors 421 are located in the closed position, the inside of the second housing 42 is closed and the reading unit 23, the printer 24, and the card unit 28 are housed on the inside of the second housing 42.

The third doors 421 include a reading window 4212 of the reading unit 23, a dispensing port 4211 for discharging a receipt to be dispensed from the printer 24, and an insertion port 4213 for inserting a card into the card unit 28.

The second housing 42 includes a display unit 22 in an upper part. The display unit 22 displays commodity information of a commodity subjected to commodity registration processing involved in the commodity registration operation by the customer. The display unit 22 displays checkout information in the case in which checkout processing involved in the checkout operation by the customer is performed. The display unit 22 includes a touch panel 21 on the surface thereof. The touch panel 21 plays roles of keys. If the customer operates the touch panel 21 in positions corresponding to various keys displayed on the display unit 22, whereby the keys are operated.

The second housing 42 includes, in a rear part thereof, a columnar pole 46 extending upward. A light emitting unit 29 is provided at the upper tip portion of the pole 46. The light emitting unit 29 emits light if the customer performs operation for calling an attendant.

The customer takes out a commodity from a basket placed on the placing table 25, causes the commodity to pass the front of the reading window 4212, and causes the reading unit 23 to read a code symbol attached to the commodity. The customer puts the commodity in a bag placed on the placing table 26. The self-service POS terminal 1 determines, according to whether a weight change before and after take-out of the commodity measured by the first measurement unit 251 and a weight change before and after deposit of the commodity measured by the second measurement unit 261 coincide, whether the customer is correctly operating the self-service POS terminal 1. If the weight changes coincide, the self-service POS terminal 1 executes the commodity registration processing.

Subsequently, a hardware configuration of the self-service POS terminal 1 is explained. FIG. 2 is a block diagram illustrating the hardware configuration of the self-service POS terminal 1. As illustrated in FIG. 2, the self-service POS terminal 1 includes a CPU (Central Processing Unit) 11, a ROM (Read Only Memory) 12, a RAM (Random Access Memory) 13, and a memory unit 14. The CPU 11 is an example of a processor and is a control entity. The ROM 12 stores various programs. Various data are loaded in the RAM 13. The memory unit 14 stores various programs. The CPU 11, the ROM 12, the RAM 13, and the memory unit 14 are connected to one another via a data bus 15. The CPU 11, the ROM 12, and the RAM 13 configure a control unit 100. That is, the CPU 11 operates according to a control program stored in the ROM 12 and the memory unit 14 and loaded in the RAM 13, whereby the control unit 100 executes control processing explained below.

The RAM 13 includes a commodity information unit 131 and a deposit amount storage unit 132. The commodity information unit 131 stores commodity information (a commodity code, a commodity name, a commodity price, and the like) of a commodity subjected to the commodity registration processing. The deposit amount storage unit 132 receives, from the coin change machine 271, information concerning the numbers for each of denominations and a deposit amount of coins deposited to the coin change machine 271 in the transaction (coin amount information) and stores the information. The deposit amount storage unit 132 receives, from the bill change machine 272, information concerning the numbers for each of denominations and a deposit amount of bills deposited to the bill change machine 272 in the transaction (bill amount information) and stores the information.

The memory unit 14 is configured by a nonvolatile memory such as an HDD (Hard Disc Drive) or a flash memory in which stored information is retained even if power is turned off and includes a control program unit 141 that stores the control program and a reference denomination unit 142. The reference denomination unit 142 stores an amount of a coin to be dispensed as change that is changed to a coin of a minimum denomination. For example, if a ten-yen coin is stored as the coin of the minimum denomination, if coins (5-yen coins and 1-yen coins) smaller in amount than the 10-yen coin are included in coins deposited to the coin change machine 271, and if the coins are dispensed as change, if a deposit amount of the smaller amount coins is an amount that can be dispensed with coins of the minimum denomination, the smaller amount coins are dispensed with coins of an amount equal to or more than the 10-yen coins. For example, if one 10-yen coin and two 5-yen coins and ten 1-yen coins are included in deposited coins and if the coins are dispensed as change, the two 5-yen coins and the ten 1-yen coins are changed to 10-yen coins and three 10-yen coins are dispensed as change. If an amount of deposited small amount coins is less than an amount of a reference coin, the small amount coins are directly dispensed as change. For example, if one 5-yen coin and three 1-yen coins are deposited, a total amount of the coins is 8 yen and cannot be changed to a 10-yen coin. Therefore, the one 5-yen coin and three 1-yen coins are dispensed.

The control unit 100 is communicably connected to the touch panel 21, the display unit 22, the reading unit 23, the printer 24, the coin change machine 271, the bill change machine 272, and the card unit 28 via the data bus 15 and a controller 16.

The touch panel 21 includes keys such as a start key 211, a deposit and cash total key 213, and an other closing key 214 corresponding to the display of the keys of the display unit 22. The customer operates the start key 211 if the customer starts commodity registration operation for a commodity. The customer operates the deposit and cash total key 213 if the customer ends the commodity registration operation for the commodity and shifts to checkout processing for making payment by cash. If the deposit and cash total key 213 is operated, the self-service POS terminal 1 starts the checkout processing by cash.

The display unit 22 is formed by, for example, an LCD (Liquid Crystal Display) and displays information to the customer. The reading unit 23 is configured by, for example, a camera and reads a code symbol attached to a commodity. The printer 24 is configured by, for example, a thermal printer and prints commodity information and checkout information of a commodity subjected to the checkout processing and dispenses a receipt. The card unit 28 reads information from, for example, a credit card.

The control unit 100 is connected to a communication unit 36 via the data bus 15. The communication unit 36 is connected to other self-service POS terminals 1 and a store server (not illustrated) via a communication line NT.

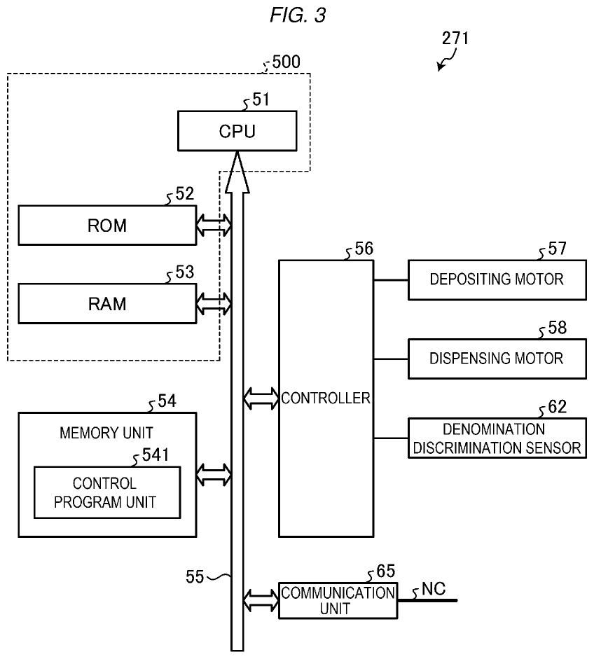

FIG. 3 is a block diagram illustrating a hardware configuration of the coin change machine 271. In FIG. 3, the coin change machine 271 includes a CPU 51, a ROM 52, a RAM 53, and a memory unit 54. The CPU 51 is an example of a processor and is a control entity. The ROM 52 stores various programs. Various data are loaded in the RAM 53. The memory unit 54 stores various programs. The CPU 51, the ROM 52, the RAM 53, and the memory unit 54 are connected to one another via a data bus 55. The CPU 51, the ROM 52, and the RAM 53 configure a control unit 500. That is, the CPU 51 operates according to a control program stored in the ROM 52 and the memory unit 54 and loaded in the RAM 53, whereby the control unit 500 executes control processing explained below.

The memory unit 54 is configured by a nonvolatile memory such as an HDD or a flash memory in which stored information is retained even if power is turned off and includes a control program unit 541 that stores the control program.

The control unit 500 is connected to a depositing motor 57, a dispensing motor 58, and a denomination discrimination sensor 62 via the data bus 55 and a controller 56. The depositing motor 57 is a motor for conveying coins deposited to the depositing section 2711 and storing the coins in a storing section (not illustrated). The dispensing motor 58 is a motor for conveying the coins stored in the storing section to the coin dispensing port 273 and dispensing the coins. The denomination discrimination sensor 62 is a sensor that discriminates denominations of deposited coins and counts the numbers of the deposited coins.

The control unit 500 is connected to a communication unit 65 via the data bus 55. The communication unit 65 is connected to the controller 16 via a communication cable NC.

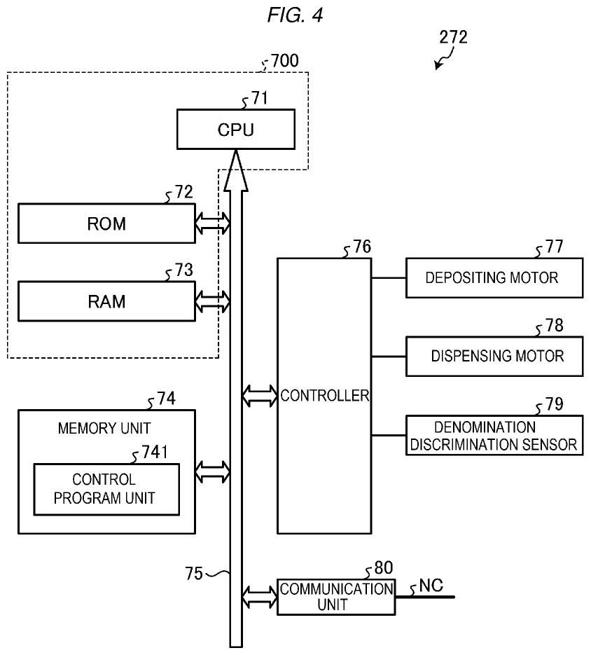

FIG. 4 is a block diagram illustrating a hardware configuration of the bill change machine 272. In FIG. 4, the bill change machine 272 includes a CPU 71, a ROM 72, a RAM 73, and a memory unit 74. The CPU 71 is an example of a processor and is a control entity. The ROM 72 stores various programs. Various data are loaded in the RAM 73. The memory unit 74 stores various programs. The CPU 71, the ROM 72, the RAM 73, and the memory unit 74 are connected to one another via a data bus 75. The CPU 71, the ROM 72, and the RAM 73 configure a control unit 700. That is, the CPU 71 operates according to a control program stored in the ROM 72 and the memory unit 74 and loaded in the RAM 73, whereby the control unit 700 executes control processing explained below.

The memory unit 74 is configured by a nonvolatile memory such as an HDD or a flash memory in which stored information is retained even if power is turned off and includes a control program unit 741 that stores the control program.

The control unit 700 is connected to a depositing motor 77, a dispensing motor 78, and a denomination discrimination sensor 79 via the data bus 75 and a controller 76. The depositing motor 77 is a motor for conveying bills deposited to the bill depositing port 274 and storing the bills in a storing section (not illustrated). The dispensing motor 78 is a motor for conveying the bills stored in the storing section to the bill dispensing port 275 and dispensing the bills. The denomination discrimination sensor 79 is a sensor that discriminates denominations of the deposited bills and counts the numbers of bills.

The control unit 500 is connected to a communication unit 80 via the data bus 75. The communication unit 80 is connected to the controller 16 via the communication cable NC.

A functional configuration of the self-service POS terminal 1 is explained below. FIG. 5 is a functional block diagram illustrating the functional configuration of the self-service POS terminal 1. The control unit 100 follows the control program stored in the ROM 12 and the control program unit 141 of the memory unit 14 to function as a change calculation unit 101, a first determination unit 102, a second determination unit 103, a dispensing form determination unit 104, a dispensing denomination determination unit 105, a confirmation unit 106, and a change unit 107.

In one transaction, the change calculation unit 101 calculates a change amount based on a purchase amount of a commodity, coin amount information indicating an amount of coins deposited to the coin change machine 271, and bill amount information indicating an amount of bills deposited to the bill change machine 272. Specifically, the change calculation unit 101 calculates a change amount based on a purchase amount of a commodity, information concerning an amount of coins among coin amount information received from the coin change machine 271 and including the numbers for each of denominations of coins deposited to the coin change machine 271 and an amount of the deposited coins, and information concerning an amount of bills among bill amount information received from the bill change machine 272 and including the numbers for each of denominations of bills deposited to the bill change machine 272 and an amount of the deposited bills.

The first determination unit 102 determines whether the amount of the coins indicated by the coin amount information received from the coin change machine 271 (that is, the amount of the coins deposited to the coin change machine 271) is equal to or more than the amount of the minimum amount bill. For example, in Japan, the minimum amount bill is a 1000-yen bill having the minimum amount among issued bills. Therefore, the first determination unit 102 determines whether the amount of the coins indicated by the coin amount information received from the coin change machine 271 is equal to or more than 1000 yen.

The second determination unit 103 determines whether the change amount calculated by the change calculation unit 101 is equal to or more than the amount of the minimum amount bill. In the embodiment, the second determination unit 103 determines whether the change amount calculated by the change calculation unit 101 is equal to or more than 1000 yen, which is the amount of the 1000-yen bill that is the minimum amount bill.

If the first determination unit 102 determines that the amount of the coins indicated by the coin amount information received from the coin change machine 271 is equal to or more than the amount of the minimum amount bill and the second determination unit 103 determines that the change amount calculated by the change calculation unit 101 is equal to or larger than the amount of the minimum amount bill, the dispensing form determination unit 104 determines a dispensing form of the change amount calculated by the change calculation unit 101 (an amount of change to be dispensed with coins by the coin change machine 271 and an amount of change to be dispensed with bills by the bill change machine 272). Specifically, if the first determination unit 102 determines that the amount of the coins indicated by the coin amount information received from the coin change machine 271 is equal to or more than the amount of the minimum amount bill and the second determination unit 103 determines that the change amount calculated by the change calculation unit 101 is equal to or more than the amount of the minimum amount bill, the dispensing form determination unit 104 determines that the entire amount of the change amount is dispensed with coins if the change amount is equal to or smaller than the amount deposited to the coin change machine 271. If the first determination unit 102 determines that the amount of the coins indicated by the coin amount information received from the coin change machine 271 is equal to or more than the amount of the minimum amount bill and the second determination unit 103 determines that the change amount calculated by the change calculation unit 101 is equal to or more than the amount of the minimum amount bill and if the change amount exceeds the amount deposited to the coin change machine 271, the dispensing form determination unit 104 determines an amount of change to be dispensed with coins by the coin change machine 271 and an amount of change to be dispensed with bills by the bill change machine 272 for dispensing change with bills until the change becomes equal to or less than the amount deposited to the coin change machine 271 and dispensing the remaining change with coins (a dispensing method of a case (5) explained below). That is, the dispensing form determination unit 104 determines an amount to be dispensed from the coin change machine 271 with the amount of the coins deposited to the coin change machine 271 set as an upper limit.

The dispensing denomination determination unit 105 determines, based on presence or absence of coins smaller in amount than the reference denomination among the deposited coins, a denomination of change to be dispensed. Specifically, if coins smaller in amount compared with the reference amount of the coins stored in the reference denomination unit 142 is deposited to the coin change machine 271, the dispensing denomination determination unit 105 determines that the smaller amount coins are changed to coins of an amount equal to or more than the reference amount and dispensed. For example, if ten 100-yen coins and ten 10-yen coins are deposited to the coin change machine 271 and the reference amount is 100 yen, the dispensing denomination determination unit 105 determines that the ten 10-yen coins are changed to one 100-yen coin and eleven 100-yen coins are dispensed as change. For example, if ten 100-yen coins and eleven 10-yen coins are deposited to the coin change machine 271 and the reference amount is 100 yen, the dispensing denomination determination unit 105 determines that the ten 10-yen coins are changed to one 100-yen coin and eleven 100-yen coins and one 10-yen coin are dispensed as change. If coins smaller in amount compared with the reference amount of the coins stored in the reference denomination unit 142 are not deposited to the coin change machine 271, the dispensing denomination determination unit 105 determines that the coins are dispensed without changing types of the coins.

If the first determination unit 102 determines that the amount of the coins indicated by the coin amount information is equal to or more than the amount of the minimum amount bill and the second determination unit 103 determines that the change amount is equal to or more than the amount of the minimum amount bill, the confirmation unit 106 confirms with the customer whether it is appropriate to dispense the amount equal to or more than the amount of the minimum amount bill as change with coins. Specifically, if the first determination unit 102 determines that the amount of the coins indicated by the coin amount information is equal to or more than the amount of the minimum amount bill and the second determination unit 103 determines that the change amount is equal to or more than the amount of the minimum amount bill, the confirmation unit 106 displays, on the display unit 22, whether it is appropriate to dispense the amount equal to or more than the amount of the minimum amount bill as change with coins.

If the first determination unit 102 determines that the amount of the coins is equal to or more than the amount of the minimum amount bill and the second determination unit 103 determines that the change amount is equal to or more than the amount of the minimum amount bill, the change unit 107 outputs, to the coin change machine 271, a coin dispensing signal for dispensing the amount equal to or more than the amount of the minimum amount bill in the change amount with coins. In the embodiment, if the first determination unit 102 determines that the amount of the coins deposited to the coin change machine 271 is equal to or more than an amount of a 1000-yen bill (that is, 1000 yen) and the second determination unit 103 determines that the change amount is equal to or more than the amount of the 1000-yen bill (that is, 1000 yen), the change unit 107 outputs, to the coin change machine 271, a coin dispensing signal for dispensing the amount equal to or more than the amount of the 1000-yen bill (that is, 1000 yen) in the change amount with coins. Specifically, if the first determination unit 102 determines that the amount of the coins is equal to or more than the amount of the minimum amount bill and the second determination unit 103 determines that the change amount is equal to or more than the amount of the minimum amount bill, the change unit 107 designates a denomination determined by the dispensing form determination unit 104 and the dispensing denomination determination unit 105 and outputs, to the coin change machine 271, a coin payment signal for dispensing the amount equal to or more than the amount of the minimum amount bill in the change amount with coins.

The coin dispensing signal output by the change unit 107 is illustrated about cases explained below.
(1) If a 100-yen commodity is purchased and ten 100-yen coins and ten 10-yen coins (a deposit amount of the coins is 1100 yen in total and is equal to or more than the 1000-yen bill that is the minimum amount bill) are deposited to the coin change machine 271, the amount of the commodity is settled with the 100-yen coins and a change amount is 1000 yen (the change amount is equal to or more than the amount of the minimum amount bill). In this case, since the change amount does not exceed the deposited amount of the coins, the change unit 107 dispenses the entire amount of the change amount of 1000 yen with coins. That is, since the deposit amount with coins of 1100 yen is equal to or more than one minimum amount bill (1000-yen bill) and equal to or less than the input amount to the coin change machine 271, the coin unit 107 outputs a coin dispensing signal for dispensing the entire change amount with coins (that is, a coin dispensing signal for dispensing an amount equal to more than the amount of the minimum amount bill in the change amount with coins). Since coins less than the reference denomination (for example, 100 yen) are changed to coins equal to or more than the reference denomination and change is dispensed with the coins equal to or more than the reference denomination, the change unit 107 outputs a coin dispensing signal for changing the deposited ten 10-yen coins to one 100-yen coin and dispensing the change with ten 100-yen coins.
(2) If a 1100-yen commodity is purchased and one 1000-yen bill, ten 100-yen coins, and ten 10-yen coins (a deposit amount of the coins is 1100 yen in total and is equal to or more than the 1000-yen bill that is the minimum amount bill) are deposited to the coin change machine 271, the amount of the commodity is settled by the 1000-yen bill and one 100-yen coin and a change amount is 1000 yen (the change amount is equal to or more than the amount of the minimum amount bill). In this case, since the change amount does not exceed the deposit amount of the coins, the change unit 107 dispenses the change amount of 1000 yen with the coins. That is, since the deposit amount by the coins of 1100 yen is equal to or more than one minimum amount bill (1000-yen bill) and is equal to or less than the deposit amount to the coin change machine 271, the change unit 107 outputs a coin dispensing signal for dispensing the entire change amount with coins (that is, a coin dispensing signal for dispensing an amount equal to or more than the amount of the minimum amount bill in the change amount with coins). Since coins less than the reference denomination (for example, 100 yen) are changed to coins equal to or more than the reference denomination and change is dispensed with the coins equal to or more than the reference denomination, the change unit 107 outputs a coin dispensing signal for changing the deposited ten 10-yen coins to one 100-yen coin and dispensing the change with ten 100-yen coins.
(3) If a 1100-yen commodity is purchased and two 1000-yen bills, ten 100-yen coins, and ten 10-yen coins (a deposit amount of the coins is 1100 yen in total and is equal to or more than the 1000-yen bill that is the minimum amount bill) are deposited to the coin change machine 271, the amount of the commodity is settled by the 1000-yen bill and one 100-yen coin and a change amount is 2000 yen (the change amount is equal to or more than the amount of the minimum amount bill). In this case, since the change amount exceeds the deposit amount of the coins, the change unit 107 dispenses 1000 yen of the change amount of 2000 yen with the bills and dispenses the remaining 1000 yen with coins. That is, the change unit 107 outputs a coin dispensing signal for dispensing the change amount with bills until the change amount becomes equal to or less than the deposit amount to the coin change machine 271 and equal to or more than the amount of the minimum amount bill and dispensing the remaining amount with coins (that is, a coin dispensing signal for dispensing an amount equal to or more than the amount of the minimum amount bill in the change amount with coins). Since coins less than the reference denomination (for example, 100 yen) are changed to coins equal to or more than the reference denomination and change is dispensed with the coins equal to or more than the reference denomination, the change unit 107 outputs a coin dispensing signal for changing the deposited ten 10-yen coins to one 100-yen coin and dispensing the change with ten 100-yen coins.
(4) If a 2000-yen commodity is purchased and one 5000-yen bill, ten 100-yen coins, and ten 10-yen coins (a deposit amount of the coins is 1100 yen in total and is equal to or more than the 1000-yen bill that is the minimum amount bill) are deposited to the coin change machine 271, the amount of the commodity is settled by the 5000-yen bill and a change amount is 4100 yen (the change amount is equal to or more than the amount of the minimum amount bill). In this case, since the change amount exceeds the deposit amount of the coins, the change unit 107 dispenses 3000 yen (5000 yen-2000 yen) of the change amount of 4100 yen with the bills and dispenses the remaining 1100 yen with coins. That is, the change unit 107 outputs a coin dispensing signal for dispensing the change amount with bills until the change amount becomes equal to or less than the deposit amount to the coin change machine 271 and equal to or more than the amount of the minimum amount bill and dispensing the remaining amount with coins (that is, a coin dispensing signal for dispensing an amount equal to or more than the amount of the minimum amount bill in the change amount with coins). Since coins less than the reference denomination (for example, 100 yen) are changed to coins equal to or more than the reference denomination and change is dispensed with the coins equal to or more than the reference denomination, the change unit 107 outputs a coin dispensing signal for changing the deposited ten 10-yen coins to one 100-yen coin and dispensing the change with eleven 100-yen coins.
(5) If a 2000-yen commodity is purchased and one 5000-yen bill, twenty 100-yen coins, and ten 10-yen coins (a deposit amount of the coins is 2100 yen in total and is equal to or more than the 1000-yen bill that is the minimum amount bill) are deposited to the coin change machine 271, the amount of the commodity is settled by the 5000-yen bill and a change amount is 5100 yen (the change amount is equal to or more than the amount of the minimum amount bill). In this case, since the change amount exceeds the deposit amount of the coins, the change unit 107 dispenses 3000 yen (5000 yen-2000 yen) of the change amount of 5100 yen with the bills and dispenses the remaining 2100 yen with coins. That is, the change unit 107 outputs a coin dispensing signal for dispensing the change amount with bills until the change amount becomes equal to or less than the deposit amount to the coin change machine 271 and equal to or more than the amount of the minimum amount bill and dispensing the other with coins (that is, a coin dispensing signal for dispensing an amount equal to or more than the amount of the minimum amount bill in the change amount with coins). Since coins less than the reference denomination (for example, 100 yen) are changed to coins equal to or more than the reference denomination and change is dispensed with the coins equal to or more than the reference denomination, the change unit 107 outputs a coin dispensing signal for changing the deposited ten 10-yen coins to one 100-yen coin and dispensing the change with twenty-one 100-yen coins.
(6) If a 6000-yen commodity is purchased and one 5000-yen bill, twenty 100-yen coins, and ten 10-yen coins (a deposit amount of the coins is 2100 yen in total and is equal to or more than the 1000-yen bill that is the minimum amount bill) are deposited to the coin change machine 271, the amount of the commodity is settled by the 5000-yen bill and ten 100-yen coins and a change amount is 1100 yen (the change amount is equal to or more than the amount of the minimum amount bill). In this case, since the change amount does not exceed the deposit amount of the coins to the coin change machine 271, the change unit 107 dispenses the entire amount of the change amount of 1100 yen with coins. That is, although 2100 yen of the deposit amount with coins is equal to or more than two minimum amount bills (1000-yen bills), since the change amount is 1100 yen, the change unit 107 outputs a coin dispensing signal for dispensing change for one minimum amount bill+a fraction with coins (that is, a coin dispensing signal for dispensing an amount equal to or more than the amount of the minimum amount bill in the change amount with coins). Since coins less than the reference denomination (for example, 100 yen) are changed to coins equal to or more than the reference denomination and change is dispensed with the coins equal to or more than the reference denomination, the change unit 107 outputs a coin dispensing signal for changing the deposited ten 10-yen coins to one 100-yen coin and dispensing the change with eleven 100-yen coins.

As explained above, if the first determination unit 102 determines that an amount of coins indicated by coin amount information received from the coin change machine 271 (that is, an amount of coins deposited to the coin change machine 271) is equal to or more than the amount of the minimum amount bill and the second determination unit 103 determines that a change amount calculated by the change calculation unit 101 is equal to or more than the amount of the minimum amount bill, amounts to be dispensed by the coin change machine 271 and the bill change machine 272 are determined by the dispensing form determination unit 104 and a denomination to be dispensed is determined by the dispensing denomination determination unit 105. The change unit 107 sets a deposit amount of the coins deposited to the coin change machine 271 as an upper limit and outputs, to the coin change machine 271, a coin dispensing signal for dispensing an amount equal to or more than the amount of the minimum amount bill in the change amount with coins.

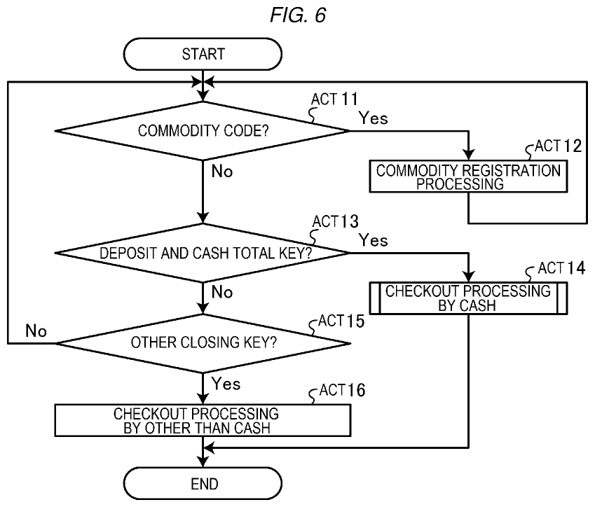

Control of the self-service POS terminal 1 is explained below. FIG. 6 is a flowchart illustrating a flow of control processing of the self-service POS terminal 1. As illustrated in FIG. 6, the control unit 100 of the self-service POS terminal 1 determines whether a code symbol attached to a commodity was read and a commodity code for specifying the commodity was acquired (Act 11). If determining that a commodity code was acquired (Yes in Act 11), the control unit 100 executes commodity registration processing for the commodity based on the acquired commodity code (Act 12). The control unit 100 returns to Act 11. If determining that a commodity code was not acquired (No in Act 11), the control unit 100 determines whether the deposit and cash total key 213 was operated (Act 13). If determining that the deposit and cash total key 213 was operated (Yes in Act 13), the control unit 100 executes checkout processing by cash (Act 14).

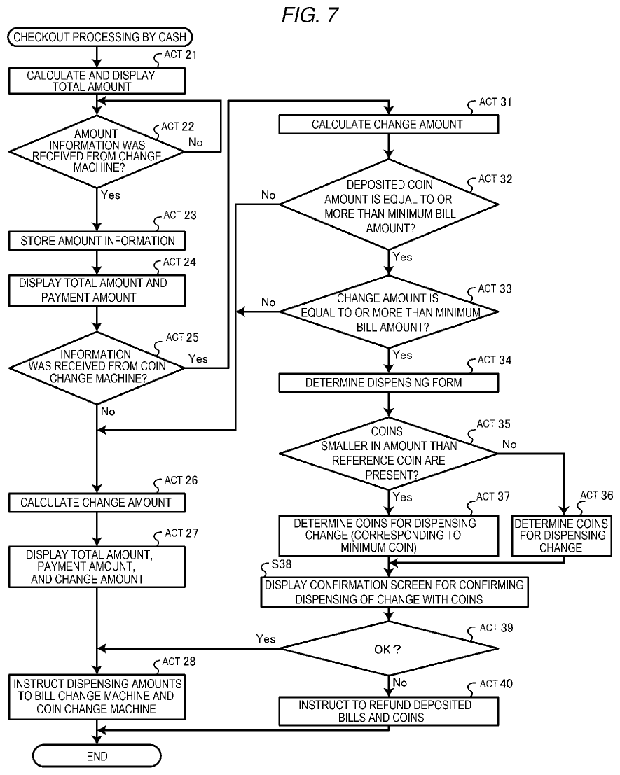

The checkout processing by cash executed in Act 14 is explained. FIG. 7 is a flowchart illustrating a flow of the checkout processing by cash of the self-service POS terminal 1. As illustrated in FIG. 7, the control unit 100 calculates, based on the commodity information stored in the commodity information unit 131, a total amount of a commodity subjected to the commodity registration processing in the transaction and displays the total amount on the display unit 22 (Act 21).

Subsequently, the control unit 100 determines whether coin amount information (in the embodiment, information concerning the numbers for each of denominations of coins deposited to the coin change machine 271 and an amount of the deposited coins) and bill amount information (in the embodiment, information concerning the numbers for each of denominations of bills deposited to the bill change machine 272 and an amount of the deposited bills) were received from the coin change machine 271 and the bill change machine 272 (Act 22). If coins were deposited to only the coin change machine 271, the control unit 100 receives coin amount information from the coin change machine 271. If bills were deposited to only the bill change machine 272, the control unit 100 receives bill amount information from the bill change machine 272. If coins were deposited to the coin change machine 271 and bills were deposited to the bill change machine 272, the control unit 100 receives coin amount information from the coin change machine 271 and receives bill amount information from the bill change machine 272.

The control unit 100 stays on standby until coin amount information or/and bill amount information are received (No in Act 22). If determining that that coin amount information or/and bill amount information (hereinafter, coin amount information and bill amount information are collectively referred to as “amount information”) were received (Yes in Act 22), the control unit 100 stores the received amount information in the deposit amount storage unit 132 (Act 23). The control unit 100 displays, on the display unit 22, the stored amount information (a total amount of an amount of the deposited coins and an amount of the deposited bills) and the total amount of the commodity subjected to the commodity registration processing (Act 24).

Subsequently, the control unit 100 determines whether coin amount information was received from the coin change machine 271 in Act 22 (Act 25). If coin amount information was not received from the coin change machine 271 (that is, bill amount information was received only from the bill change machine 272) (No in Act 25), the control unit 100 calculates a change amount based on the bill amount information displayed in Act 24 (the amount deposited to the bill change machine 272), which is a payment amount, and the total amount of the commodity (Act 26). The control unit 100 displays the total amount, the payment amount, and the change amount on the display unit 22 (Act 27).

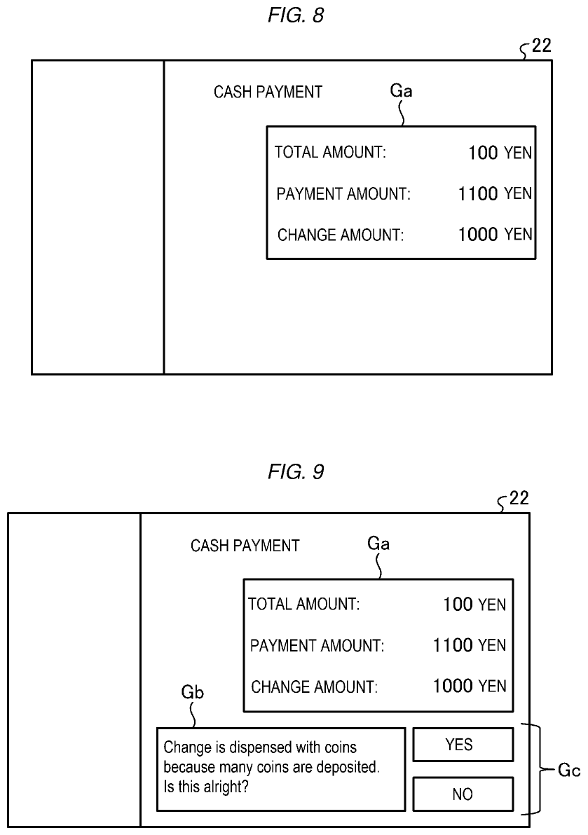

An example of a display image displayed on the display unit 22 in Act 26 is illustrated in FIG. 8. As illustrated in FIG. 8, the control unit 100 displays, on the display unit 22, an indication Ga of a total amount of a commodity, a deposited payment amount, and a change amount. The customer views the indication Ga and checks a total amount of a purchased commodity, a deposited payment amount, and a change amount.

Referring back to FIG. 7, subsequently, the control unit 100 transmits (outputs), to the bill change machine 272, a bill dispensing signal including dispensing information for bills in the calculated change amount and transmits (outputs), to the coin change machine 271, a coin dispensing signal including dispensing information for coins in the change amount (Act 28). In the case of the example illustrated in FIG. 8, since the change amount is 1000 yen, the control unit 100 transmits a bill dispensing signal for dispensing 1000 yen to the bill change machine 272 and does not transmit a coin dispensing signal to the coin change machine 271. The control unit 100 ends the processing.

If determining in Act 25 that coin amount information was received from the coin change machine 271 (bill amount information was received from the bill change machine 272; in the embodiment, in the following explanation, it is assumed that both of coin amount information and bill amount information were received) (Yes in Act 25), the change calculation unit 101 calculates a change amount based on the total amount of the coin amount information (the amount deposited to the coin change machine 271) and the bill amount information (the amount deposited to the bill change machine 272) displayed in Act 24, which is a payment amount, and the total amount of the commodity (Act 31).

Subsequently, the first determination unit 102 determines whether the amount of the coins indicated by the coin amount information received from the coin change machine 271 (that is, the amount of the coins deposited to the coin change machine 271) is equal to or more than the amount (in the embodiment, 1000 yen) of the minimum amount bill (in the embodiment, the 1000-yen bill) (Act 32). If determining that the amount of the coins indicated by the coin amount information received from the coin change machine 271 is equal to or more than the amount of the minimum amount bill (Yes in Act 32), subsequently, the second determination unit 103 determines whether the change amount calculated by the change calculation unit 101 is equal to or more than the amount (in the embodiment, 1000 yen) of the minimum amount bill (in the embodiment, the 1000-yen bill) (Act 33).

If it is determined that the change amount calculated by the change calculation unit 101 is equal to or more than the amount of the minimum amount bill (Yes in Act 33), the dispensing form determination unit 104 determines, based on the calculated change amount, the amount of the coins deposited to the coin change machine 271, and the amount of the minimum amount bill, an amount that the coin change machine 271 dispenses and an amount that the bill change machine 272 dispenses in the amount of the change (Act 34).

Subsequently, the control unit 100 determines, based on information concerning denominations of coins included in the receive coin amount information, whether coins smaller in amount than the reference denomination (in the embodiment, for example, 100 yen) stored in the reference denomination unit 142 are included in the coins deposited to the coin change machine 271 (Act 35).

If it is determined that coins smaller in amount than the reference denomination are not included (No in Act 35), the dispensing denomination determination unit 105 determines a denomination of a change amount dispensed with coins and a denomination of a change amount dispensed with bills in the change amount calculated in Act 31 (Act 36). That is, the dispensing denomination determination unit 105 determines that the change amount to be paid by the coin change machine 271 is dispensed with the denomination of the coins included in the received coin amount information (the denomination and the number of coins deposited to the coin change machine 271) (Act 36). For example, if the number information for each of the denominations included in the coin amount information is ten 100-yen coins and ten 10-yen coins, the dispensing denomination determination unit 105 determines the numbers for each of the denominations to dispense the change with the same denominations. The dispensing denomination determination unit 105 determines that the remaining change amount is dispensed with bills (Act 36).

If it is determined that coins smaller in amount than the reference denomination are included (Yes in Act 35), the dispensing denomination determination unit 105 determines denominations to be dispensed with coins and the numbers of coins as in Act 36 (Act 37). In this case, if the coins smaller in amount than the reference denomination can be paid with the coins of the reference denomination (for example, ten 10-yen coins), the dispensing denomination determination unit 105 determines the numbers for each of denominations of change to be dispensed by changing the coins smaller in amount to coins of the reference denomination (Act 37). For example, if there are nine 10-yen coins, since the coins cannot be changed to the reference denomination, the dispensing denomination determination unit 105 determines the numbers for each of denominations of change to be dispensed with the coins smaller in amount.

After the processing in Act 36 or the processing in Act 37, the confirmation unit 106 displays, on the display unit 22, a confirmation screen for confirming with the customer whether it is appropriate to dispense an amount equal to or more than the amount of the minimum amount bill as change with coins (Act 38).

In FIG. 9, an example of the confirmation screen displayed in Act 38 is illustrated. As illustrated in FIG. 9, the confirmation unit 106 displays, on the display unit 22, the indication Ga of a total amount of a commodity, a deposited payment amount, and a change amount, a message Gb for confirming that change is dispensed with many coins, and operable buttons Gc (in the embodiment, “YES” and “NO” buttons Gc) with which the customer shows an intention about appropriateness for the message Gb. The customer views the indication Ga to check a total amount of a purchased commodity, a deposited payment amount, and a change amount, views the message Gb to confirm that change is dispensed with many coins, and shows an intention about appropriateness for payment of the change with the many coins by operating the “YES” button Gc if approving the dispensing and operating the “NO” button Gc if not approving the dispensing.

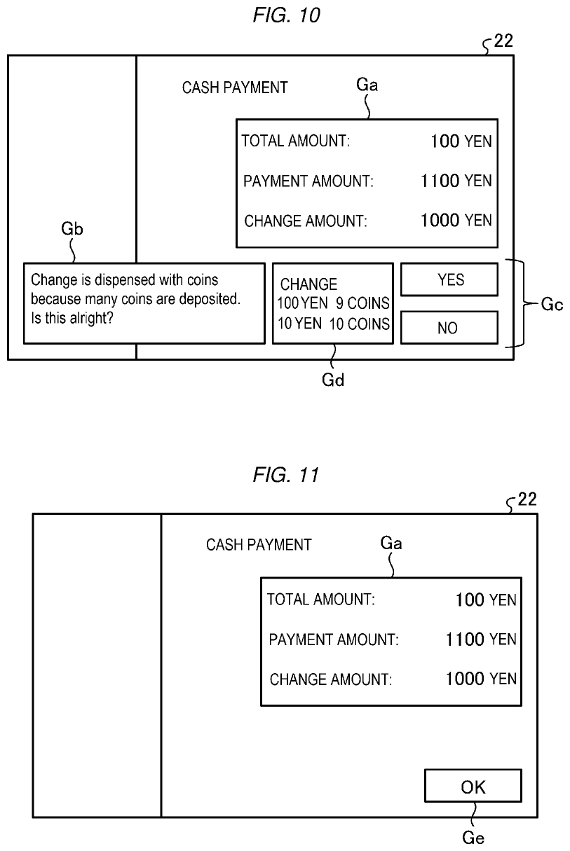

In FIG. 10, another example of the confirmation screen displayed in Act 38 is illustrated. As illustrated in FIG. 10, the confirmation unit 106 displays the indication Ga, the message Gb, and the buttons Gc on the display unit 22. The confirmation unit 106 displays, on the display unit 22, an indication Gd of the numbers for each of denominations of coins to be dispensed as change (in the embodiment, nine 100-yen coins and ten 10-yen coins). The customer views the indication Ga to check a total amount of a purchased commodity, a deposited payment amount, and a change amount, views the message Gb to confirm that change is dispensed with many coins, views the indication Gd to check the numbers for each of denominations of change to be dispensed, and shows an intention about appropriateness for dispensing of the change with the many coins by operating the “YES” button Gc if approving the dispensing and operating the “NO” button Gc if not approving the dispensing.

Referring back to FIG. 7, the control unit 100 determines whether the “YES” button Gc was operated and the dispensing of the change with many coins was approved (Act 39). If it is determined that the dispensing of the change with many coins was approved (in the embodiment, the “YES” button Gc was operated) (Yes in Act 39), the change unit 107 transmits, to the coin change machine 271, a coin dispensing signal including the change amount and the number information for each of denominations determined in Act 34, Act 36, or Act 37 (Act 28). The change unit 107 transmits, to the bill change machine 272, a bill dispensing signal including information concerning a change amount to be dispensed with bills (Act 28).

If it is determined that the dispensing of the change with the many coins was not approved (in the embodiment, the “NO” button Gc was operated) (No in Act 39), the change unit 107 transmits a refund signal for refunding the coins deposited to the coin change machine 271 and displays, on the display unit 22, a message for urging normal deposit that is not deposit of many coins (Act 40). The control unit 100 ends the processing.

If the first determination unit 102 determines in Act 32 that the amount of the coins indicated by the coin amount information received from the coin change machine 271 is not equal to or more than the amount of the minimum amount bill (in the embodiment, the 1000-yen bill) (No in Act 32) and if the second determination unit 103 determines in Act 33 that the change amount calculated by the calculation unit 101 is not equal to or more than the amount of the minimum amount bill (No in Act 33), the control unit 100 executes the processing in Act 26.

It is not essential to display the message Gb and the indication Gd illustrated in FIGS. 9 and 10. For example, as illustrated in FIG. 11, the confirmation unit 106 may display, on the display unit 22, the indication Ga and an operable button Gc indicating “OK”. In this case, the customer only has to check a total amount, a payment amount, and a change amount displayed as the indication Ga and operate the “OK” button Ge.

Referring back to FIG. 6, if determining that the deposit and cash total key 213 was not operated (No in Act 13), the control unit 100 determines whether the other closing key 214 was operated (Act 15). If determining that the other closing key 214 was operated (Yes in Act 15), the control unit 100 executes checkout processing by other than cash corresponding to a type of the other closing key 214 (Act 16). The control unit 100 ends the processing. If determining that the other closing key 214 was not operated (No in Act 15), the control unit 100 returns to Act 11.

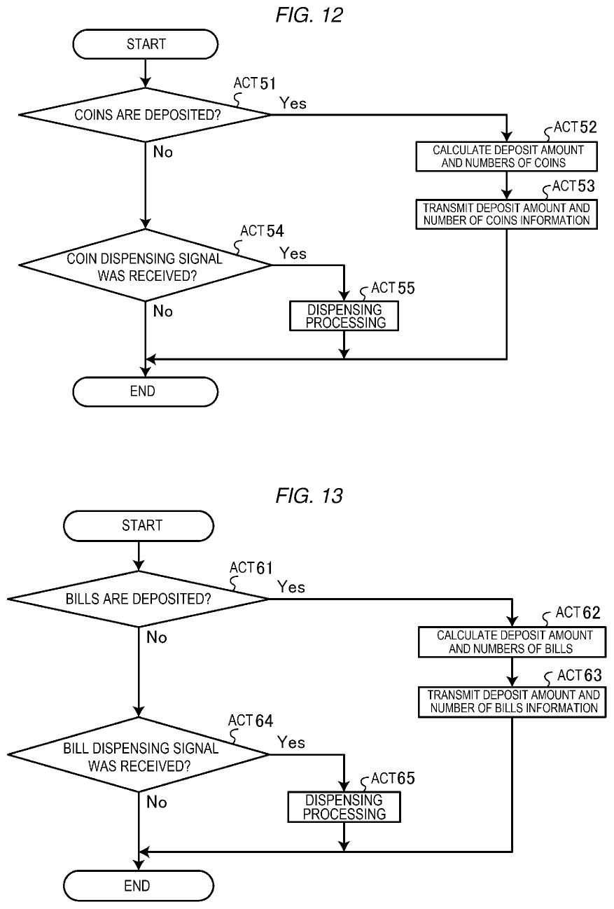

Control of the coin change machine 271 is explained below. FIG. 12 is a flowchart illustrating a flow of control processing of the coin change machine 271. As illustrated in FIG. 12, the control unit 500 of the coin change machine 271 determines whether coins were deposited from the depositing section 2711 (Act 51). If determining that coins were deposited, the control unit 500 drives the depositing motor 57, conveys the coins and stores the coins in the storing section, and counts the numbers for each of denominations of the conveyed coins using the denomination discrimination sensor 62, and calculates a deposit amount (Act 52). The control unit 500 transmits (outputs) coin amount information including the numbers for each of the denominations and the deposit amount to the controller 16 (Act 53). The control unit 500 ends the processing.

If determining that coins were not deposited (No in Act 51), the control unit 500 determines whether the coin dispensing signal transmitted in the processing in Act 28 was received (Act 54). If determining that the coin dispensing signal was received (Yes in Act 54), the control unit 500 drives the dispensing motor 58 and executes dispensing processing for dispensing coins of denominations and the number conforming to the number information for each of the denominations included in the coin dispensing signal from the storing section to the coin dispensing port 273 (Act 55). The control unit 500 ends the processing. If determining that the coin dispensing signal was not received (No in Act 54), the control unit 500 ends the processing and returns to Act 51.

Control of the bill change machine 272 is explained below. FIG. 13 is a flowchart illustrating a flow of control processing of the bill change machine 272. As illustrated in FIG. 13, the control unit 700 of the bill change machine 272 determines whether bills were deposited from the bill depositing port 274 (Act 61). If determining that bills were deposited, the control unit 700 drives the depositing motor 77, conveys the bills and stores the bills in the storing section, counts the numbers for each of denominations of the conveyed bills using the denomination discrimination sensor 79, and calculates a deposit amount (Act 62). The control unit 700 transmits (outputs) bill amount information including the numbers for each of the denominations and the deposit amount to the controller 16 (Act 63). The control unit 700 ends the processing.

If determining that bills were not deposited (No in Act 61), the control unit 700 determines whether the bill dispensing signal transmitted in the processing in Act 28 was received (Act 64). If determining that the bill dispensing signal was received (Yes in Act 64), the control unit 700 drives the dispensing motor 78 and executes dispensing processing for dispensing bills of denominations and the numbers conforming to the number information for each of the denominations included in the bill dispensing signal from the storing section to the bill dispensing port 275 (Act 65). The control unit 700 ends the processing. If determining that the bill dispensing signal was not received (No in Act 64), the control unit 700 ends the processing and returns to Act 61.

As explained above, the self-service POS terminal 1 in the embodiment is the self-service POS terminal 1 in which a customer himself or herself performs checkout operation relating to purchase of a commodity, the self-service POS terminal 1 including the coin change machine 271 that is capable of storing deposited coins and dispenses the stored coins as change and outputs coin amount information relating to an amount of coins deposited in one transaction, the bill change machine 272 that is capable of storing deposited bills and dispenses the stored bills as change and outputs bill amount information relating to an amount of bills deposited in one transaction, the change calculation unit 101 that calculates a change amount based on a purchase amount of the commodity and the output coin amount information and the output bill amount information, the first determination unit 102 that determines whether the amount of coins included in the coin amount information input from the coin change machine 271 is equal to or more than an amount of a minimum amount bill, the second determination unit 103 that determines whether the calculated change amount is equal to or more than the amount of the minimum amount bill, and the change unit 107 that, if the first determination unit 102 determines that the amount of the coins is equal to or more than the amount of the minimum amount bill and the second determination unit 103 determines that the change amount is equal to or more than the amount of the minimum amount bill, outputs, to the coin change machine 271, a coin dispensing signal for dispensing, with coins, an amount not exceeding the amount of the deposited coins and equal to or more than the amount of the minimum amount bill in the change amount.

If the amount of the coins included in the coin amount information input from the coin change machine 271 is equal to or more than the amount of the minimum amount bill and the calculated change amount is equal to or more than the amount of the minimum amount bill, the self-service POS terminal 1 in the embodiment explained above outputs, to the coin change machine 271, the coin dispensing signal for dispensing, with coins, an amount not exceeding the amount of the coins deposited to the coin change machine 271 and equal to or more than the amount of the minimum amount bill. The coin change machine 271 dispenses coins as change based on the coin dispensing signal. Therefore, it is possible to prevent reverse exchange.

The self-service POS terminal 1 in the embodiment explained above can, by preventing the reverse exchange, prevent the storing section from being immediately filled with many coins deposited to the coin change machine 271.

While the embodiment is explained above, this embodiment is presented as an example and is not intended to limit the scope of invention. This new embodiment can be implemented in other various forms. Various omissions, substitutions, and changes can be made in a range not departing from the gist of the invention. This embodiment and modifications thereof are included in the scope and the gist of the invention and included in the inventions described in the claims and a scope of equivalents of the inventions.

For example, in the embodiment, the coin amount information includes the numbers for each of the denominations of the deposited coins and the amount of the deposited coins. However, not only this, but the coin amount information may be only information concerning the amount of the deposited coins. In this case, the change unit 107 transmits, to the coin change machine 271, as a dispensing signal, information concerning an amount dispensed by the coin change machine 271. The coin change machine 271 dispenses, based on the received dispensing signal, as change, coins dispensed by the minimum number. In the embodiment, the bill amount information includes the numbers for each of the denominations of the deposited bills and the amount of the deposited bills. However, not only this, but the bill amount information may be only information concerning the amount of the deposited bills.

In the embodiment, if the coins smaller in amount than the reference denomination are deposited, the coin dispensing signal for converting the coins into the coins of the reference amount and dispensing the coins is output. However, not only this, but, if the coins smaller in amount than the reference denomination are deposited, a coin dispensing signal for directly dispensing the coins smaller in amount without converting the coins into the coins of the reference amount may be output.

In the embodiment, if the change is dispensed with many coins, the confirmation unit 106 confirms with the customer whether it is appropriate to dispense the change with many coins. However, the confirmation unit 106 is not an essential requirement.

In the embodiment, the self-service POS terminal 1 is explained as an example of the checkout apparatus. However, not only this, but, for example, a checkout apparatus in which a customer performs checkout operation in a semi-self-service POS may be the checkout apparatus.

What is claimed is:

1. A self-checkout apparatus, comprising:
a coin change machine configured to store deposited coins and dispense the stored coins as change and output coin amount information relating to an amount of coins deposited in one transaction;
a bill change machine configured to store deposited bills and dispense the stored bills as change and output bill amount information relating to an amount of bills deposited in one transaction;
a change calculation component configured to calculate a change amount based on a purchase amount of a commodity and the output coin amount information and the output bill amount information;
a first determination component configured to determine whether the amount of coins included in the coin amount information input from the coin change machine is equal to or more than an amount of a minimum amount bill;
a second determination component configured to determine whether the calculated change amount is equal to or more than the amount of the minimum amount bill; and
a change component configured to, if the first determination component determines that the amount of the coins is equal to or more than the amount of the minimum amount bill and the second determination component determines that the change amount is equal to or more than the amount of the minimum amount bill, output, to the coin change machine, a coin dispensing signal to dispense, with coins, an amount not exceeding the amount of the deposited coins and equal to or more than the amount of the minimum amount bill in the change amount.

2. The self-checkout apparatus according to claim 1, wherein
the coin amount information includes information concerning numbers for each denomination of the coins deposited to the coin change machine, and
the bill amount information includes information concerning numbers for each denomination of the bills deposited to the bill change machine.

3. The self-checkout apparatus according to claim 1, further comprising a confirmation component configured to, if the first determination component determines that the amount of the coins indicated by the coin amount information is equal to or more than the amount of the minimum amount bill and the second determination component determines that the change amount is equal to or more than the amount of the minimum amount bill, confirm with a customer whether to dispense the amount equal to or more than the amount of the minimum amount bill as change with coins, wherein
the change component outputs the coin dispensing signal the customer confirms that the amount of money equal to or more than the amount of the minimum amount bill is dispensed as change with coins.

4. The self-checkout apparatus according to claim 3, wherein the confirmation component displays an amount and a number for each denomination of coins dispensed to the customer.

5. The self-checkout apparatus according to claim 2, further comprising:
a reference denomination storage component configured to store a reference denomination of coins; and
a determination component configured to determine, based on presence or absence of coins smaller in amount than the reference denomination in the deposited coins, a denomination of coins to be dispensed, wherein
the change component dispenses change with the determined denomination.

6. The self-checkout apparatus according to claim 1, further comprising:
a registration component to optically read a code symbol of the commodity.

7. The self-checkout apparatus according to claim 6, further comprising:
a display to display commodity information including at least one of a commodity name and a commodity price based on the code symbol.

8. A checkout method for a self-checkout apparatus, the self-checkout apparatus including a coin change machine configured to store deposited coins and dispense the stored coins as change and output coin amount information relating to an amount of coins deposited in one transaction and a bill change machine configured to store deposited bills and dispense the stored bills as change and output bill amount information relating to an amount of bills deposited in one transaction,
the checkout method comprising:
calculating a change amount based on a purchase amount of a commodity and the output coin amount information and the output bill amount information;
determining whether the amount of coins included in the coin amount information input from the coin change machine is equal to or more than an amount of a minimum amount bill;
determining whether the calculated change amount is equal to or more than the amount of the minimum amount bill; and
if the amount of the coins is equal to or more than the amount of the minimum amount bill and the change amount is equal to or more than the amount of the minimum amount bill, outputting, to the coin change machine, a coin dispensing signal to dispense, with coins, an amount not exceeding the amount of the deposited coins and equal to or more than the amount of the minimum amount bill in the change amount.

9. The checkout method according to claim 8, wherein
the coin amount information includes information concerning numbers for each denomination of the coins deposited to the coin change machine, and
the bill amount information includes information concerning numbers for each denomination of the bills deposited to the bill change machine.

10. The checkout method according to claim 8, further comprising:
if the amount of the coins indicated by the coin amount information is equal to or more than the amount of the minimum amount bill and the change amount is equal to or more than the amount of the minimum amount bill, confirming with a customer whether to dispense the amount equal to or more than the amount of the minimum amount bill as change with coins; and
outputting the coin dispensing signal that the customer confirms that the amount of money equal to or more than the amount of the minimum amount bill is dispensed as change with coins.

11. The checkout method according to claim 10, further comprising:
displaying an amount and a number for each denomination of coins dispensed to the customer.

12. The checkout method according to claim 9, further comprising:
storing a reference denomination of coins;
determining, based on presence or absence of coins smaller in amount than the reference denomination in the deposited coins, a denomination of coins to be dispensed; and
dispensing change with the determined denomination.

13. The checkout method according to claim 8, further comprising:
optically reading a code symbol of the commodity.

14. A self service POS terminal, comprising:
a registration component;
a coin change machine configured to store deposited coins and dispense the stored coins as change and output coin amount information relating to an amount of coins deposited in one transaction;
a bill change machine configured to store deposited bills and dispense the stored bills as change and output bill amount information relating to an amount of bills deposited in one transaction;
a change calculation component configured to calculate a change amount based on a purchase amount of a commodity and the output coin amount information and the output bill amount information;
a first determination component configured to determine whether the amount of coins included in the coin amount information input from the coin change machine is equal to or more than an amount of a minimum amount bill;
a second determination component configured to determine whether the calculated change amount is equal to or more than the amount of the minimum amount bill; and
a change component configured to, if the first determination component determines that the amount of the coins is equal to or more than the amount of the minimum amount bill and the second determination component determines that the change amount is equal to or more than the amount of the minimum amount bill, output, to the coin change machine, a coin dispensing signal to dispense, with coins, an amount not exceeding the amount of the deposited coins and equal to or more than the amount of the minimum amount bill in the change amount.

15. The self service POS terminal according to claim 14, wherein
the coin amount information includes information concerning numbers for each denomination of the coins deposited to the coin change machine, and
the bill amount information includes information concerning numbers for each denomination of the bills deposited to the bill change machine.

16. The self service POS terminal according to claim 14, further comprising a confirmation component configured to, if the first determination component determines that the amount of the coins indicated by the coin amount information is equal to or more than the amount of the minimum amount bill and the second determination component determines that the change amount is equal to or more than the amount of the minimum amount bill, confirm with a customer whether to dispense the amount equal to or more than the amount of the minimum amount bill as change with coins, wherein
the change component outputs the coin dispensing signal the customer confirms that the amount of money equal to or more than the amount of the minimum amount bill is dispensed as change with coins.

17. The self service POS terminal according to claim 16, wherein the confirmation component displays an amount and a number for each denomination of coins dispensed to the customer.

18. The self service POS terminal according to claim 15, further comprising:
a reference denomination storage component configured to store a reference denomination of coins; and
a determination component configured to determine, based on presence or absence of coins smaller in amount than the reference denomination in the deposited coins, a denomination of coins to be dispensed, wherein
the change component dispenses change with the determined denomination.

19. The self service POS terminal according to claim 14, further comprising:
the registration component to optically read a code symbol of the commodity.

20. The self service POS terminal according to claim 19, further comprising:
a display to display commodity information including at least one of a commodity name and a commodity price based on the code symbol.
